(19) United States
(12) Patent Application Publication
(10) Pub. No.: US 2026/0235053 A1
(43) Pub. Date: Aug. 13, 2026

(54) ENGINE

(71) Applicants: ISHIKAWA ENERGY RESEARCH CO., LTD., Ota-shi, Gunma (JP); KUBOTA CORPORATION, Ota-shi, Gunma (JP)

(72) Inventor: Taro Fukuda, Ota-shi, Gunma (JP)

(73) Assignees: ISHIKAWA ENERGY RESEARCH CO., LTD., Ota-shi, Gunma (JP); KUBOTA CORPORATION, Ota-shi, Gunma (JP)

(21) Appl. No.: 19/155,654

(22) PCT Filed: Jul. 31, 2023
(86) PCT No.: PCT/JP2023/027905

§ 371 Date: Aug. 12, 2025

(51) Int. Cl. F01L 1/04; F01L 1/14; F02B 75/28

(52) U.S. Cl. CPC F01L 1/04; F01L 1/146; F02B 75/28

(57) ABSTRACT

The present invention provides an engine that can optimize valves and their advancing/retreating mechanisms in the vicinity of a cylinder chamber. The engine 10 comprises: a cylinder chamber 12, an intake valve 18, an exhaust valve 19, and an advancing/retreating mechanism 20 that advances and retreats the intake valve 18 and the exhaust valve 19. The advancing/retreating mechanism 20 has a camshaft 21, an exhaust cam 22, an intake cam 23, a pushrod 24, and a rocker arm 25. The intake cam 23 is fixed to the camshaft 21 and is configured to advance and retreat the intake valve 18. The exhaust cam 22 is configured to advance and retreat the pushrod 24. The rocker arm 25 is rotated by the pushrod 24 and is configured to advance and retreat the exhaust valve 19.

### TECHNICAL FIELD

The present invention relates to an engine, and particularly, relates to an opposed-piston engine.

### BACKGROUND ART

Conventionally, opposed-piston engines, as shown in Patent Literature 1 and Patent Literature 2, commonly had a structure in which pistons having piston heads that face each other perform linear motion within one cylinder arranged in a horizontal direction. Within this cylinder, the region where the piston heads face each other functions as a combustion chamber, and by an air-fuel mixture undergoing ignition and explosion, the pistons operate, and power is supplied to an external actuator such as a generator.

However, in the engines described in such patent literatures, because the combustion chamber volume is small, achieving a high compression ratio is difficult, and there is also an issue with insulating the combustion chamber. Also, the intake and exhaust valves of conventional opposed-piston engines are directly open to the combustion chamber, and there was a drawback that the volume of the combustion chamber becomes large.

In order to solve such issues, the engine described in Patent Literature 3 was invented. In the engine described in Patent Literature 3, independent left and right pistons are arranged within a horizontal cylinder so as to face each other. Also, one combustion chamber is formed between the left and right piston heads, communicating with the outside of the horizontal cylinder. Furthermore, in the engine described in Patent Literature 3, an extension part extending laterally from the combustion chamber is formed. In this extension part, a spark plug is provided.

### CITATION LIST

### Patent LITERATURE

Patent Literature 1: Japanese Patent Application Publication No. 2007-46534

Patent Literature 2: Japanese Patent Application Publication No. Hei 8 -93498

Patent Literature 3: Japanese Patent 5508604

### SUMMARY OF THE INVENTION

### Technical Problem

However, in the opposed-piston engines described in the aforementioned patent literatures, there was room for improvement from the viewpoint of optimization of the advancing/retreating mechanism that controls the advancing/retreating operation of the valves.

Specifically, in the opposed-piston engine described in Patent Literature 3, when the direction in which the pistons reciprocate is taken as the front-rear direction, the intake valves and exhaust valves were collectively arranged to the front or rear of the extension part. Furthermore, the advancing/retreating mechanisms for the intake valves and exhaust valves also are arranged in the vicinity of the intake valves and exhaust valves. Therefore, there was an issue that the mechanical configuration around the extension part becomes complicated.

Also, in an opposed-piston engine, if one attempts to arrange multiple cylinder chambers for achieving higher output, there is an issue that such problems become prominent.

The present invention has been made in view of such problems, and an object of the present invention is to provide an engine that can optimize the valves and their advancing/retreating mechanisms in the vicinity of the cylinder chamber.

### Solution to Problem

An engine of the present invention comprises: a cylinder chamber, an intake valve, an exhaust valve, and an advancing/retreating mechanism that advances and retreats the intake valve and the exhaust valve, wherein the advancing/retreating mechanism has a camshaft, a first cam, a second cam, a pushrod, and a rocker arm, the first cam is fixed to the camshaft and is configured to advance and retreat one of the intake valve and the exhaust valve, the second cam is separate from the first cam and is configured to advance and retreat the pushrod, and the rocker arm is rotated by the pushrod and is configured to advance and retreat the other of the intake valve and the exhaust valve.

Also, in the engine of the present invention, the first cam advances and retreats a plurality of the intake valves, and the second cam, via the pushrod, advances and retreats the exhaust valve.

Also, in the engine of the present invention, inside the cylinder chamber, when the axial direction of the cylinder chamber is taken as a front-rear direction, pistons oppositely arranged along the front-rear direction are arranged so as to reciprocate, it has an extension space extending laterally from an intermediate portion of the cylinder chamber in the front-rear direction, each of the intake valves is provided so as to be capable of advancing and retreating with respect to the extension space from a front side, and the exhaust valve is provided so as to be capable of advancing and retreating with respect to the extension space from a rear side.

Also, in the engine of the present invention, the cylinder chamber has a first cylinder chamber and a second cylinder chamber adjacent to the first cylinder chamber, inside the first cylinder chamber, a first piston and a second piston are housed so as to reciprocate, inside the second cylinder chamber, a third piston and a fourth piston are housed so as to reciprocate, it has a first extension space extending laterally from an intermediate portion of the first cylinder chamber in the front-rear direction, it has a second extension space extending laterally from an intermediate portion of the second cylinder chamber in the front-rear direction, the intake valve has a first intake valve and a second intake valve, the exhaust valve has a first exhaust valve and a second exhaust valve, the first intake valve is provided so as to be capable of advancing and retreating with respect to the first extension space from the front side, the first exhaust valve is provided so as to be capable of advancing and retreating with respect to the first extension space from the rear side, the second intake valve is provided so as to be capable of advancing and retreating with respect to the second extension space from the front side, and the second exhaust valve is provided so as to be capable of advancing and retreating with respect to the second extension space from the rear side.

Also, in the engine of the present invention, the number of the intake valves is greater than the number of the exhaust valves, and a spark plug is arranged on the side of the extension space where the exhaust valve is provided, so as to be exposed.

### Advantageous Effects of Invention

An engine of the present invention comprises: a cylinder chamber, an intake valve, an exhaust valve, and an advancing/retreating mechanism that advances and retreats the intake valve and the exhaust valve, wherein the advancing/retreating mechanism has a camshaft, a first cam, a second cam, a pushrod, and a rocker arm, the first cam is fixed to the camshaft and is configured to advance and retreat one of the intake valve and the exhaust valve, the second cam is separate from the first cam and is configured to advance and retreat the pushrod, and the rocker arm is rotated by the pushrod and is configured to advance and retreat the other of the intake valve and the exhaust valve. According to the engine of the present invention, by advancing and retreating one of the intake valve and the exhaust valve by the first cam, and advancing and retreating the other of the intake valve and the exhaust valve by the pushrod, even when geometric constraints in the vicinity of the cylinder are severe, the advancing/retreating mechanism can be arranged in the vicinity of the cylinder. Also, since a pushrod is used, the number of camshafts is reduced, and thereby the configuration of the engine can be simplified.

Also, in the engine of the present invention, the first cam advances and retreats a plurality of the intake valves, and the second cam, via the pushrod, advances and retreats the exhaust valve. According to the engine of the present invention, the advancing/retreating mechanism that advances and retreats the intake valves and exhaust valves can be consolidated in a limited space.

Also, in the engine of the present invention, inside the cylinder chamber, when the axial direction of the cylinder chamber is taken as a front-rear direction, pistons oppositely arranged along the front-rear direction are arranged so as to reciprocate, it has an extension space extending laterally from an intermediate portion of the cylinder chamber in the front-rear direction, each of the intake valves is provided so as to be capable of advancing and retreating with respect to the extension space from a front side, and the exhaust valve is provided so as to be capable of advancing and retreating with respect to the extension space from a rear side. According to the engine of the present invention, because the intake valves and exhaust valves are arranged sandwiching the extension space, the intake valves and exhaust valves are consequently arranged densely, but because the intake valves or the exhaust valves are advanced and retreated via the pushrod, the configuration around the extension space can be simplified.

Also, in the engine of the present invention, the cylinder chamber has a first cylinder chamber and a second cylinder chamber adjacent to the first cylinder chamber, inside the first cylinder chamber, a first piston and a second piston are housed so as to reciprocate, inside the second cylinder chamber, a third piston and a fourth piston are housed so as to reciprocate, it has a first extension space extending laterally from an intermediate portion of the first cylinder chamber in the front-rear direction, it has a second extension space extending laterally from an intermediate portion of the second cylinder chamber in the front-rear direction, the intake valve has a first intake valve and a second intake valve, the exhaust valve has a first exhaust valve and a second exhaust valve, the first intake valve is provided so as to be capable of advancing and retreating with respect to the first extension space from the front side, the first exhaust valve is provided so as to be capable of advancing and retreating with respect to the first extension space from the rear side, the second intake valve is provided so as to be capable of advancing and retreating with respect to the second extension space from the front side, and the second exhaust valve is provided so as to be capable of advancing and retreating with respect to the second extension space from the rear side. According to the engine of the present invention, even when a plurality of cylinder chambers are adjacent and a large number of intake valves and exhaust valves are arranged, by optimizing the configuration of the camshaft and the pushrod, the configuration of the entire engine can be simplified.

Also, in the engine of the present invention, the number of the intake valves is greater than the number of the exhaust valves, and a spark plug is arranged on the side of the extension space where the exhaust valve is provided, so as to be exposed. According to the engine of the present invention, by the spark plug being exposed to the extension space from the side of the exhaust valves, which are fewer in number, the space around the extension space can be used effectively.

### BRIEF DESCRIPTION OF DRAWINGS

FIG. 1 is a perspective view showing an engine according to an embodiment of the present invention.

FIG. 2A is a diagram showing the engine according to the embodiment of the present invention, and is a perspective view showing a first engine block.

FIG. 2B is a diagram showing the engine according to the embodiment of the present invention, and is a perspective view showing a second engine block.

FIG. 3A is a diagram showing the engine according to the embodiment of the present invention, and is a diagram showing a first contact surface of the first engine block.

FIG. 3B is a diagram showing the engine according to the embodiment of the present invention, and is a diagram showing a second contact surface of the second engine block.

FIG. 4 is a diagram showing the engine according to the embodiment of the present invention, and is a perspective view showing an engine unit and the like.

FIG. 5 is a diagram showing the engine according to the embodiment of the present invention, and is a perspective view showing valves and an advancing/retreating mechanism.

FIG. 6 is a diagram showing the engine according to the embodiment of the present invention, and is an exploded perspective view showing the valves and the advancing/retreating mechanism.

FIG. 7A is a diagram showing the engine according to the embodiment of the present invention, and is a perspective view of a second cylinder chamber, a second extension space, and the like, as viewed from the rear.

FIG. 7B is a diagram showing the engine according to the embodiment of the present invention, and is a perspective view of the second cylinder chamber, the second extension space, and the like, as viewed from the front.

FIG. 8 is a diagram showing the engine according to the embodiment of the present invention, and is a cross-sectional view showing a wall portion of an engine block that forms a cylinder chamber and an extension space.

### DESCRIPTION OF EMBODIMENTS

Hereinafter, an engine 10 according to an embodiment of the present invention will be described in detail based on the drawings. In the following description, the front-rear direction refers to the direction in which pistons to be described later reciprocate along the axial direction of a cylinder chamber to be described later. The left-right direction refers to the direction in which cylinder spaces to be described later are arranged. In the following description, the same members are, in principle, assigned the same reference numerals, and repeated descriptions thereof are omitted. Furthermore, in the present embodiment, the configurations described in the claims are mainly illustrated and described. Therefore, parts of the engine 10 other than these configurations, for example, a crankshaft rotation synchronization mechanism, a lubricating oil supply mechanism, a fuel supply mechanism, electrical components, and the like, are not illustrated.

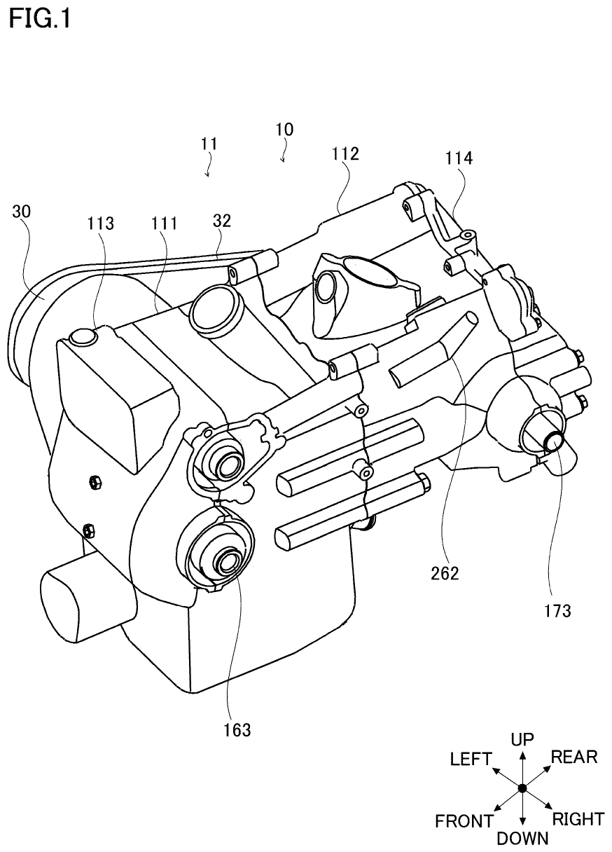

FIG. 1 is a perspective view showing the engine 10.

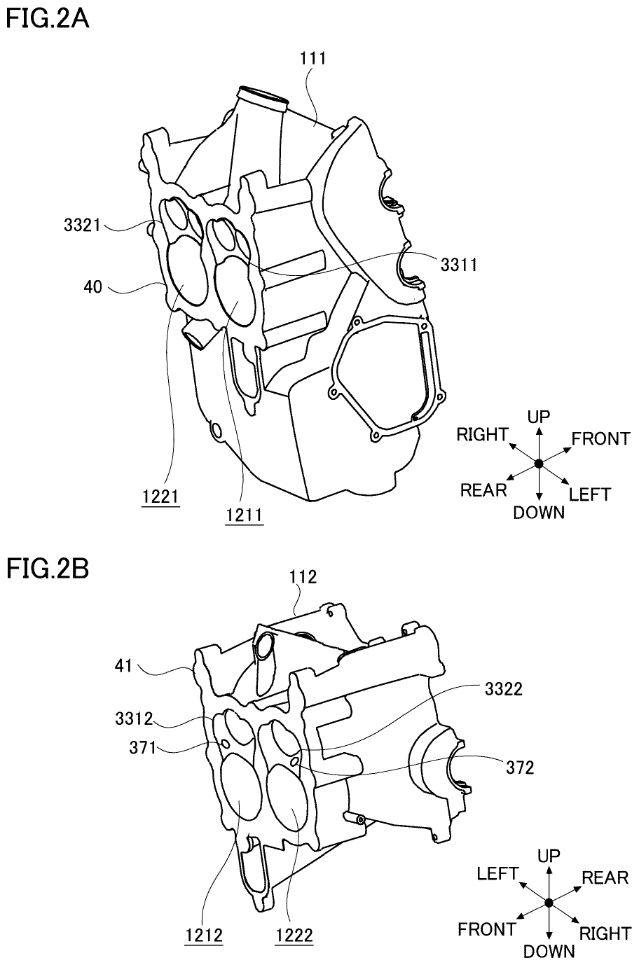

The engine 10 is an opposed-piston engine having a plurality of oppositely arranged pistons. The internal configuration and operation of the engine 10 will be described later with reference to FIG. 2A and subsequent figures.

The engine 10 is configured to be operated with gasoline, diesel oil, hydrogen, or the like as fuel. The engine 10 can be used as a drive source for various devices. The engine 10 is used as a drive source for vehicles, generators, water heaters, flight apparatuses, drones, series hybrid drones, parallel hybrid drones, and the like. A series hybrid drone refers to a drone that operates a generator by the engine 10, rotates a motor by electric power generated from the generator, rotates a rotor by the motor, and levitates an airframe in the air by lift generated by the rotation of the rotor. A parallel hybrid drone refers to a drone that mechanically rotates a main rotor by the engine 10, and levitates an airframe by lift generated by the rotation of the main rotor. The engine 10 of the present embodiment is an opposed-piston engine, and because it is lightweight and has low vibration, it is particularly suitable as a drive source for series hybrid drones, parallel hybrid drones, and the like.

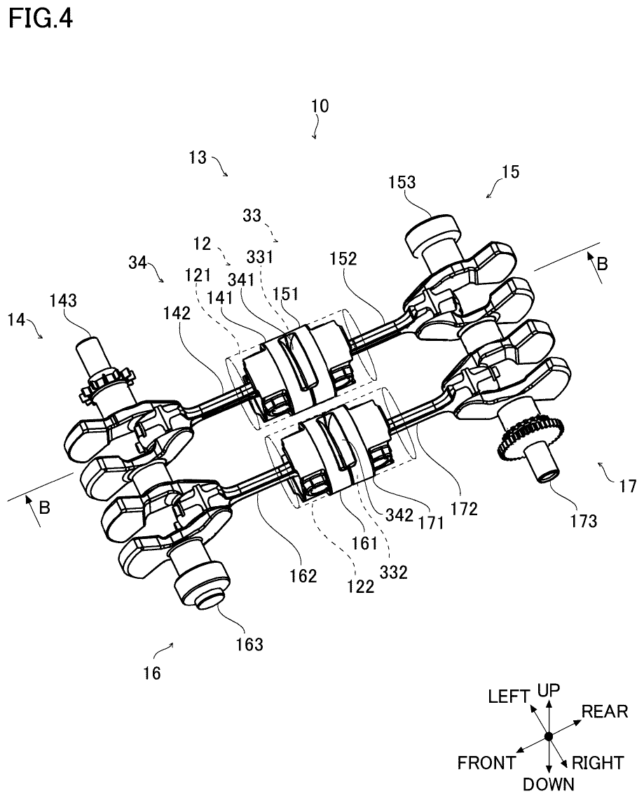

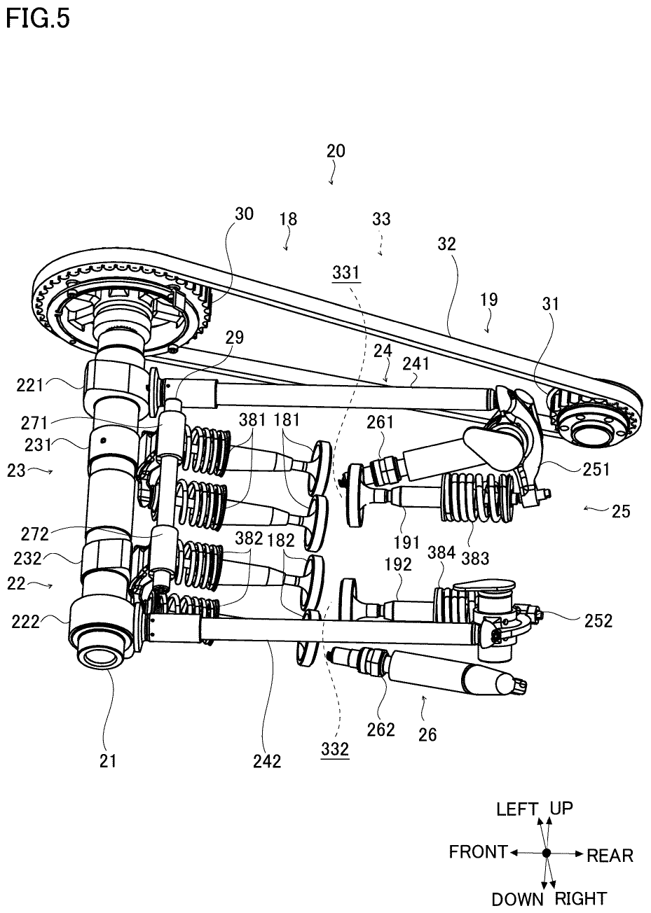

Specifically, the engine 10 comprises: a cylinder chamber 12, an intake valve 18, an exhaust valve 19, and an advancing/retreating mechanism 20. These respective parts constituting the engine 10 are housed in an engine block 11. The configuration of the cylinder chamber 12 will be described with reference to FIG. 4 and the like. The intake valve 18, the exhaust valve 19, and the advancing/retreating mechanism 20 will be described with reference to FIG. 5 and the like.

Also, the engine 10 has an engine block 11 that is a main body part. The engine block 11 is made of, for example, a cast aluminum alloy or the like. The engine block 11 is composed of a first engine block 111, a second engine block 112, a third engine block 113, and a fourth engine block 114. These respective parts are fastened to each other by fastening members such as stud bolts (not shown).

On the right side surface of the engine 10, a third crankshaft 163 and a fourth crankshaft 173 are led out. From the third crankshaft 163 and the fourth crankshaft 173, rotational power can be taken out to the outside. Also, a shaft can also be led out from the left side surface of the engine 10, and power can also be taken out to the outside from this shaft.

Also, a second spark plug 262 is attached to the right side surface of the engine block 11. Similarly, a first spark plug 261 (not shown) is attached to the left side surface of the engine block 11. Furthermore, on the left side surface side of the engine block 11, a belt 32 and a driven gear 30 for driving an advancing/retreating mechanism 20 to be described later are arranged. Regarding these devices, they will be described later with reference to FIG. 5 and subsequent figures.

FIG. 2A is a perspective view showing the first engine block 111.

Referring to FIG. 2A, the surface of the first engine block 111 facing rearward is taken as a first contact surface 40. The first contact surface 40 is a flat surface, and contacts a second contact surface 41 of a second engine block 112 to be described later.

The first engine block 111 has a first cylinder chamber front part 1211 and a second cylinder chamber front part 1221 formed extending forward from the first contact surface 40. The first cylinder chamber front part 1211 and the second cylinder chamber front part 1221 are adjacent along the left-right direction. The first cylinder chamber front part 1211 is a substantially cylindrical space, and forms a front portion of a first cylinder chamber 121 to be described later. The second cylinder chamber front part 1221 is a substantially cylindrical space, and forms a front portion of a second cylinder chamber 122 to be described later.

A first extension space front part 3311 is a portion where the first contact surface 40 is recessed forward, and is continuous with an upper end of the first cylinder chamber front part 1211. The first extension space front part 3311 constitutes a first extension space 331 to be described later.

A second extension space front part 3321 is a portion where the first contact surface 40 is recessed forward, and is continuous with an upper end of the second cylinder chamber front part 1221. The second extension space front part 3321 constitutes a second extension space 332 to be described later.

Referring to FIG. 2B, the surface of the second engine block 112 facing forward is taken as a second contact surface 41. The second contact surface 41 is a flat surface, and contacts the first contact surface 40 of the aforementioned first engine block 111.

The second engine block 112 has a first cylinder chamber rear part 1212 and a second cylinder chamber rear part 1222 formed extending rearward from the second contact surface 41. The first cylinder chamber rear part 1212 and the second cylinder chamber rear part 1222 are adjacent along the left-right direction. The first cylinder chamber rear part 1212 is a substantially cylindrical space, and forms a rear portion of a first cylinder chamber 121 to be described later. The second cylinder chamber rear part 1222 is a substantially cylindrical space, and forms a rear portion of a second cylinder chamber 122 to be described later.

A first extension space rear part 3312 is a portion where the second contact surface 41 is recessed rearward, and is continuous with an upper end of the first cylinder chamber rear part 1212. The first extension space rear part 3312, together with the aforementioned first extension space front part 3311, constitutes a first extension space 331 to be described later.

A second extension space rear part 3322 is a portion where the second contact surface 41 is recessed rearward, and is continuous with an upper end of the second cylinder chamber rear part 1222. The second extension space rear part 3322, together with the aforementioned second extension space front part 3321, constitutes a second extension space 332 to be described later.

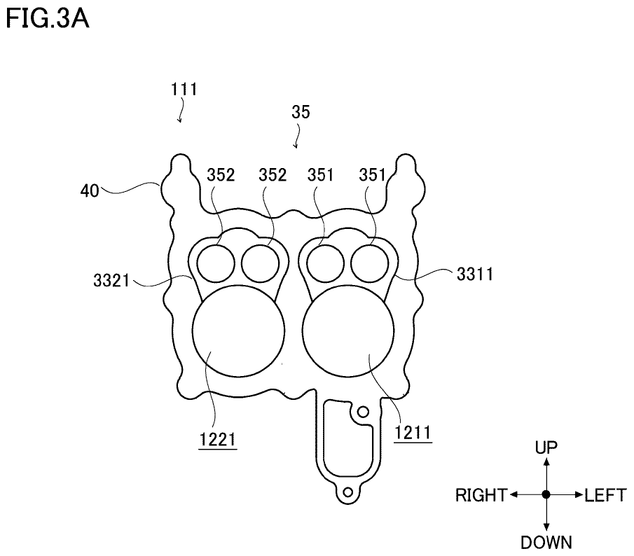

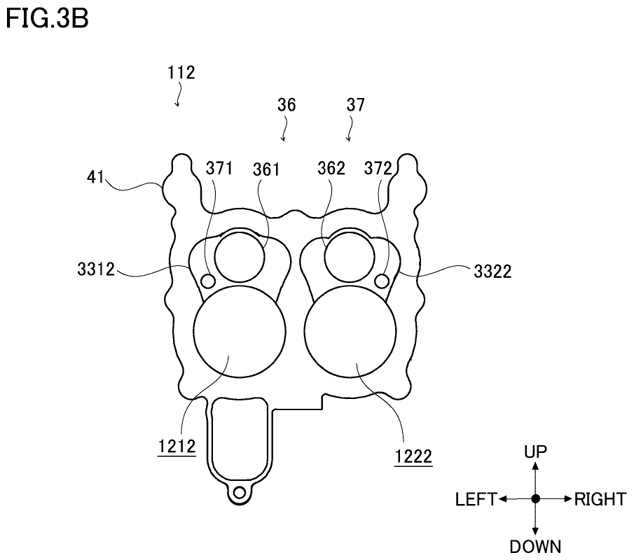

FIG. 3A is a diagram showing the first contact surface 40 of the first engine block 111. Intake valve installation holes 35 are formed in the first contact surface 40. The intake valve installation holes 35 have first intake valve installation holes 351 and second intake valve installation holes 352.

Two first intake valve installation holes 351 are formed inside the first extension space front part 3311. The first intake valve installation holes 351 are through-holes that circularly penetrate a wall portion of the first engine block 111 in the front-rear direction. First intake valves 181, to be described later, are respectively arranged in the first intake valve installation holes 351.

Two second intake valve installation holes 352 are formed inside the second extension space front part 3321. The second intake valve installation holes 352 are through-holes that circularly penetrate a wall portion formed inside the first engine block 111. Second intake valves 182, to be described later, are respectively arranged in the second intake valve installation holes 352.

FIG. 3B is a diagram showing the second contact surface 41 of the second engine block 112. Exhaust valve installation holes 36 and plug installation holes 37 are formed in the second contact surface 41. The exhaust valve installation holes 36 have a first exhaust valve installation hole 361 and a second exhaust valve installation hole 362. Also, the plug installation holes 37 have a first plug installation hole 371 and a second plug installation hole 372.

The first exhaust valve installation hole 361 is a hole portion formed in the first extension space rear part 3312. The first exhaust valve installation hole 361 circularly penetrates a wall portion formed inside the second engine block 112. A first exhaust valve 191, to be described later, is arranged in the first exhaust valve installation hole 361.

The first plug installation hole 371 is a through-hole formed inside the first extension space rear part 3312. The first plug installation hole 371 is a through-hole that penetrates a left side surface portion of the second engine block 112. That is, a front end portion of the first plug installation hole 371 opens into the first extension space rear part 3312. Also, a rear end portion of the first plug installation hole 371 opens to the outside from the left side surface portion of the second engine block 112. A front end portion of a first spark plug 261, to be described later, is inserted into the first plug installation hole 371.

The second exhaust valve installation hole 362 is a hole portion formed in the second extension space rear part 3322. The second exhaust valve installation hole 362 circularly penetrates a wall portion formed inside the second engine block 112. A second exhaust valve 192, to be described later, is arranged in the second exhaust valve installation hole 362.

The second plug installation hole 372 is a through-hole formed inside the second extension space rear part 3322. The second plug installation hole 372 is a through-hole that penetrates a right side surface portion of the second engine block 112. That is, a front end portion of the second plug installation hole 372 opens into the second extension space rear part 3322. Also, a rear end portion of the second plug installation hole 372 opens to the outside from the right side surface portion of the second engine block 112. A front end portion of a second spark plug 262, to be described later, is inserted into the second plug installation hole 372.

FIG. 4 is a perspective view of an engine unit 13 housed in the aforementioned engine block 11, as viewed from the front upper side.

The engine unit 13 has a first engine part 14, a second engine part 15, a third engine part 16, and a fourth engine part 17. The first engine part 14 and the second engine part 15 constitute one opposed engine part. The third engine part 16 and the fourth engine part 17 constitute one opposed engine part. Because the engine 10 has a plurality of opposed engine parts, high output can be achieved while ensuring lightweightness and low vibration of the engine 10.

The cylinder chamber 12 has a first cylinder chamber 121, and a second cylinder chamber 122 adjacent to the first cylinder chamber 121. The first cylinder chamber 121 and the second cylinder chamber 122 are adjacent along the left-right direction. In FIG. 4, the first cylinder chamber 121 and the second cylinder chamber 122 are indicated by dotted lines. Inside the first cylinder chamber 121, oppositely arranged first piston 141 and second piston 151 are arranged so as to reciprocate. Inside the second cylinder chamber 122, oppositely arranged third piston 161 and fourth piston 171 are arranged so as to reciprocate.

The first engine part 14 has a first piston 141, a first connecting rod 142, and a first crankshaft 143. The first connecting rod 142 rotatably connects the first piston 141 and the first crankshaft 143.

The second engine part 15 is arranged so as to oppose the first engine part 14. The second engine part 15 has a second piston 151, a second connecting rod 152, and a second crankshaft 153. The second connecting rod 152 rotatably connects the second piston 151 and the second crankshaft 153.

The third engine part 16 has a third piston 161, a third connecting rod 162, and a third crankshaft 163. The third connecting rod 162 rotatably connects the third piston 161 and the third crankshaft 163.

The fourth engine part 17 is arranged so as to oppose the third engine part 16. The fourth engine part 17 has a fourth piston 171, a fourth connecting rod 172, and a fourth crankshaft 173. The fourth connecting rod 172 rotatably connects the fourth piston 171 and the fourth crankshaft 173.

The first crankshaft 143 of the first engine part 14 and the third crankshaft 163 of the third engine part 16 are integrally continuous. Therefore, the first piston 141 of the first engine part 14 and the third piston 161 of the third engine part 16 reciprocate simultaneously.

Similarly, the second crankshaft 153 of the second engine part 15 and the fourth crankshaft 173 of the fourth engine part 17 are integrally continuous. Therefore, the second piston 151 of the second engine part 15 and the fourth piston 171 of the fourth engine part 17 reciprocate simultaneously.

The engine unit 13 has a configuration in which an opposed engine portion composed of the first engine part 14 and the second engine part 15, and an opposed engine portion composed of the third engine part 16 and the fourth engine part 17 are arranged side by side along the left-right direction. Also, the first engine part 14 and the third engine part 16 rotate the first crankshaft 143 and the third crankshaft 163. Also, the second engine part 15 and the fourth engine part 17 rotate the second crankshaft 153 and the fourth crankshaft 173. With this configuration, large power can be generated even with a compact configuration.

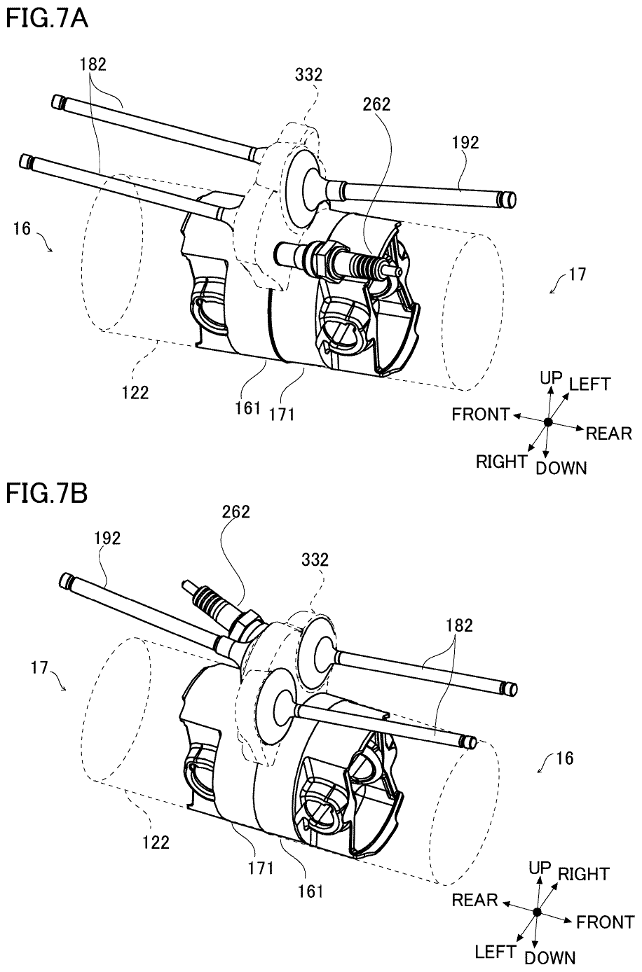

The extension space 33 is a space extending upward, which is a lateral direction, from an intermediate portion of the cylinder chamber 12 in the front-rear direction. The extension space 33 has a first extension space 331 and a second extension space 332. The first extension space 331 is a space extending upward from an intermediate portion in the front-rear direction of the first cylinder chamber 121. The second extension space 332 is a space extending upward from an intermediate portion in the front-rear direction of the second cylinder chamber 122. The first extension space 331 and the second extension space 332 are portions where respective valves and plugs are installed, as will be described later. The specific shape of the extension space 33 is shown in FIG. 7A and the like.

A combustion chamber 34 is a space sandwiched by pistons inside the cylinder chamber 12. The combustion chamber 34 has a first combustion chamber 341 and a second combustion chamber 342. The first combustion chamber 341 is a space inside the first cylinder chamber 121, sandwiched by the first piston 141 and the second piston 151, where an air-fuel mixture combusts. The first combustion chamber 341 is continuous with the first extension space 331. The second combustion chamber 342 is a space inside the second cylinder chamber 122, sandwiched by the third piston 161 and the fourth piston 171, where an air-fuel mixture combusts. The second combustion chamber 342 is continuous with the second extension space 332.

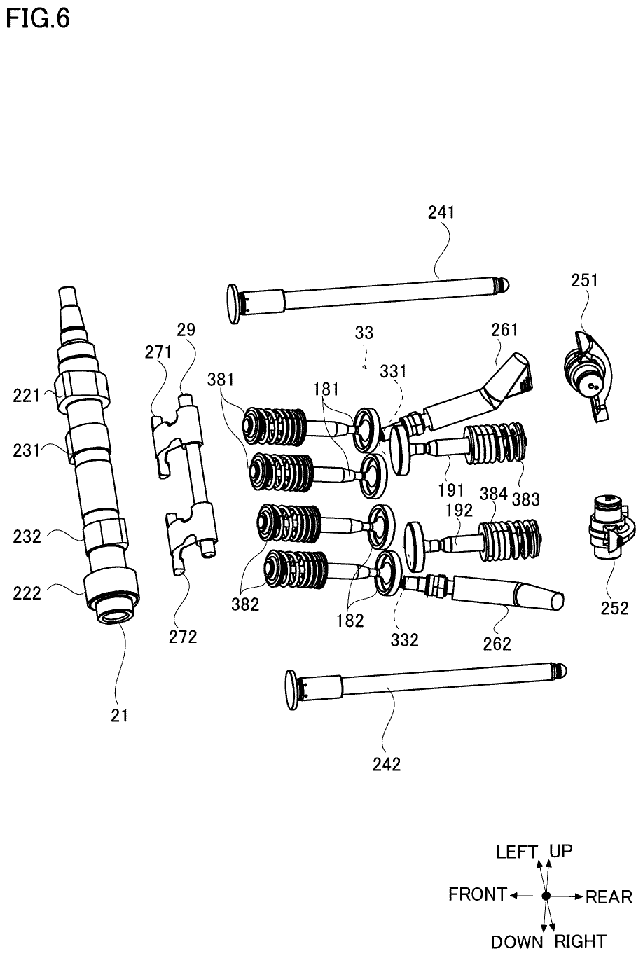

FIG. 5 is a perspective view showing each valve and the advancing/retreating mechanism 20. FIG. 6 is an exploded perspective view showing each valve and the advancing/retreating mechanism 20.

Referring to FIG. 5 and FIG. 6, the advancing/retreating mechanism 20 is a mechanism that advances and retreats the intake valve 18 and the exhaust valve 19 arranged in the vicinity of the aforementioned extension space 33.

The intake valve 18 has a first intake valve 181 and a second intake valve 182.

The first intake valve 181 is provided so as to be capable of advancing and retreating with respect to the first extension space 331 from a front side. Here, two first intake valves 181 are provided. The first intake valves 181 are respectively attached to the first intake valve installation holes 351 shown in FIG. 3A. The first intake valve 181 is for intaking an air-fuel mixture into the first cylinder chamber 121 shown in FIG. 4. Springs 381 are respectively attached to the first intake valves 181. The springs 381 urge the first intake valves 181 forward.

The second intake valve 182 is provided so as to be capable of advancing and retreating with respect to the second extension space 332 from a front side. Here, two second intake valves 182 are provided. The second intake valves 182 are respectively attached to the second intake valve installation holes 352 shown in FIG. 3A. The second intake valve 182 is for intaking an air-fuel mixture into the second cylinder chamber 122 shown in FIG. 4. Springs 382 are respectively attached to the second intake valves 182. The springs 382 urge the second intake valves 182 forward.

The exhaust valve 19 has a first exhaust valve 191 and a second exhaust valve 192.

The first exhaust valve 191 is provided so as to be capable of advancing and retreating with respect to the first extension space 331 from a rear side. Here, one first exhaust valve 191 is provided. The first exhaust valve 191 is attached to the first exhaust valve installation hole 361 shown in FIG. 3B. The first exhaust valve 191 is for exhausting an air-fuel mixture from the first cylinder chamber 121 shown in FIG. 4. A spring 383 is provided on the first exhaust valve 191. The spring 383 urges the first exhaust valve 191 rearward.

The second exhaust valve 192 is provided so as to be capable of advancing and retreating with respect to the second extension space 332 from a rear side. Here, one second exhaust valve 192 is provided. The second exhaust valve 192 is attached to the second exhaust valve installation hole 362 shown in FIG. 3B. The second exhaust valve 192 is for exhausting an air-fuel mixture from the second cylinder chamber 122 shown in FIG. 4. A spring 384 is provided on the second exhaust valve 192. The spring 384 urges the second exhaust valve 192 rearward.

The number of intake valves 18 is greater than the number of exhaust valves 19. For example, regarding the first extension space 331, the number of exhaust valves 19 is one, and the number of intake valves 18 is two. According to the present embodiment, by the spark plug 26 being exposed to the extension space 33 from the side of the exhaust valves 19, which are fewer in number, the space around the extension space 33 can be used effectively.

The advancing/retreating mechanism 20 mainly has a camshaft 21, a first cam, a second cam, a pushrod 24, and a rocker arm 25. The first cam is, for example, an intake cam 23. The second cam is separate from the first cam, and is, for example, an exhaust cam 22.

The camshaft 21 is a steel rod extending along the left-right direction. A driven gear 30 is connected to a left end portion of the camshaft 21 so as to be relatively non-rotatable. A crank gear 31 is arranged on a rear side of the driven gear 30. The crank gear 31 is connected to the aforementioned second crankshaft 153 so as to be relatively non-rotatable. A belt 32 is stretched between the driven gear 30 and the crank gear 31. Therefore, when the engine unit 13 shown in FIG. 4 operates and the second crankshaft 153 rotates, the camshaft 21 rotates via the belt 32. Thereby, the intake valve 18 and the exhaust valve 19 can be advanced and retreated at a predetermined timing.

The intake cam 23 is attached to the camshaft 21 so as to be relatively non-rotatable, and is configured to advance and retreat the intake valve 18. The intake cam 23 has a first intake cam 231 and a second intake cam 232.

The first intake cam 231 is arranged on a front side of the first intake valve 181. By the first intake cam 231 rotating, the first intake valve 181, pushed by the first intake cam 231, advances and retreats.

The second intake cam 232 is arranged on a front side of the second intake valve 182. By the second intake cam 232 rotating, the second intake valve 182, pushed by the second intake cam 232, advances and retreats.

The exhaust cam 22 is configured to advance and retreat the exhaust valve 19 via the pushrod 24. The exhaust cam 22 has a first exhaust cam 221 and a second exhaust cam 222. The exhaust cam 22 is arranged outward from the intake cam 23 in the left-right direction.

The first exhaust cam 221 is arranged on the camshaft 21 to the left side of the first intake cam 231. As will be described later, by the first exhaust cam 221 rotating, the first exhaust valve 191 advances and retreats via a first pushrod 241 and a first rocker arm 251.

The second exhaust cam 222 is arranged on the camshaft 21 to the right side of the second intake cam 232. As will be described later, by the second exhaust cam 222 rotating, the second exhaust valve 192 advances and retreats via a second pushrod 242 and a second rocker arm 252.

The pushrod 24 is a steel rod extending along the front-rear direction. The pushrod 24 has a first pushrod 241 and a second pushrod 242. The pushrod 24 is arranged at an end portion of the advancing/retreating mechanism 20 in the left-right direction.

The first pushrod 241 is arranged to the left side of the intake valve 18, the exhaust valve 19, and the extension space 33. A front end of the first pushrod 241 abuts the first exhaust cam 221. A rear end of the first pushrod 241 contacts an upper end portion of the first rocker arm 251. The first pushrod 241 is a member that transmits power generated by the rotation of the first exhaust cam 221 to the first rocker arm 251.

The second pushrod 242 is arranged to the right side of the intake valve 18, the exhaust valve 19, and the extension space 33. A front end of the second pushrod 242 abuts the second exhaust cam 222. A rear end of the second pushrod 242 contacts an upper end portion of the second rocker arm 252. The second pushrod 242 is a member that transmits power generated by the rotation of the second exhaust cam 222 to the second rocker arm 252.

The rocker arm 25 is rotated by the pushrod 24, and is configured to advance and retreat the exhaust valve 19. The rocker arm 25 has a first rocker arm 251 and a second rocker arm 252.

Referring to FIG. 6, the first rocker arm 251 is arranged so as to be rotatable with an intermediate portion in the up-down direction as a rotation center. An upper end portion of the first rocker arm 251 abuts a rear end of the first pushrod 241. A lower end portion of the first rocker arm 251 abuts a rear end of the first exhaust valve 191. The first rocker arm 251 is arranged so as to be inclined leftward, which is outward in the width direction, as it goes upward. By doing so, the first pushrod 241 can be arranged leftward, which is outward in the width direction. Therefore, the intake valve 18, the exhaust valve 19, and the spark plug 26 can be arranged in a central portion in the width direction of the advancing/retreating mechanism 20.

The second rocker arm 252 is arranged so as to be rotatable with an intermediate portion in the up-down direction as a rotation center. An upper end portion of the second rocker arm 252 abuts a rear end of the second pushrod 242. A lower end portion of the second rocker arm 252 abuts a rear end of the second exhaust valve 192. The second rocker arm 252 is arranged so as to be inclined rightward, which is outward in the width direction, as it goes upward. By doing so, the second pushrod 242 can be arranged rightward, which is outward in the width direction.

The spark plug 26 is arranged on the side where the exhaust valve 19 is provided, that is, on a rear side of the extension space 33. A tip of the spark plug 26 is arranged inside the extension space 33. The spark plug 26 has a first spark plug 261 and a second spark plug 262.

The first spark plug 261 is arranged on a left side of the first exhaust valve 191. A front end portion of the first spark plug 261 is arranged inside the first extension space 331. Referring to FIG. 2B, the first spark plug 261 penetrates a left side wall portion of the first engine block 111, and is inserted into the first extension space rear part 3312 from the first plug installation hole 371. That is, a rear portion of the first spark plug 261 is exposed to the outside from the left side wall portion of the first engine block 111. Here, a plurality of first spark plugs 261 may be arranged with respect to the first extension space 331.

The second spark plug 262 is arranged on a right side of the second exhaust valve 192. A front end portion of the second spark plug 262 is arranged inside the second extension space 332. Referring to FIG. 2B, the second spark plug 262 penetrates a right side wall portion of the first engine block 111, and is inserted into the second extension space rear part 3322 from the second plug installation hole 372. That is, a rear portion of the second spark plug 262 is exposed to the outside from the right side wall portion of the first engine block 111. Here, a plurality of second spark plugs 262 may be arranged with respect to the second extension space 332.

Referring to FIG. 6, a first arm 271 is arranged between the first intake valve 181 and the first intake cam 231. A front surface of a lower portion of the first arm 271 abuts the first intake cam 231. A rear surface of the lower portion of the first arm 271 abuts front end portions of the two first intake valves 181. An upper end portion of the first arm 271 is inserted through an arm shaft 29. With this configuration, the first arm 271 is arranged so as to be rotatable with the arm shaft 29 as a rotation center.

A second arm 272 is arranged between the second intake valve 182 and the second intake cam 232. A front surface of a lower portion of the second arm 272 abuts the second intake cam 232. A rear surface of the lower portion of the second arm 272 abuts front end portions of the two second intake valves 182. An upper end portion of the second arm 272 is inserted through the arm shaft 29. With this configuration, the second arm 272 is arranged so as to be rotatable with the arm shaft 29 as a rotation center.

The intake valve 18 and the exhaust valve 19 close the extension space 33 when driving force from the advancing/retreating mechanism 20 is not applied. That is, when the first intake valve 181 is not pushed by the first intake cam 231 and the first arm 271, it closes the first extension space 331 by an urging force of the spring 381. When the first exhaust valve 191 is not pushed by the first exhaust cam 221, the first pushrod 241, and the first rocker arm 251, it closes the first extension space 331 by an urging force of the spring 383. When the second intake valve 182 is not pushed by the second intake cam 232 and the second arm 272, it closes the second extension space 332 by an urging force of the spring 382. When the second exhaust valve 192 is not pushed by the second exhaust cam 222, the second pushrod 242, and the second rocker arm 252, it closes the second extension space 332 by an urging force of the spring 384.

FIG. 7A is a perspective view of the second cylinder chamber 122, the second extension space 332, and the like, as viewed from the rear upper side. Here, the second cylinder chamber 122 and the second extension space 332 are indicated by dotted lines. The second extension space 332 is a space extending upward from a central portion of the second cylinder chamber 122 in the front-rear direction. On a rear side surface of the second extension space 332, the second exhaust valve 192 and the second spark plug 262 are arranged.

FIG. 7B is a perspective view of the second cylinder chamber 122, the second extension space 332, and the like, as viewed from the front upper side. Here, the second cylinder chamber 122 and the second extension space 332 are indicated by dotted lines. Two second intake valves 182 are connected to a front side surface of the second extension space 332.

The engine unit 13, the first engine part 14, the second engine part 15, and the advancing/retreating mechanism 20 of the above-described configuration operate by repeating an intake stroke, a compression stroke, a combustion stroke, and an exhaust stroke as follows.

In the intake stroke, referring to FIG. 4, by the first piston 141 and the second piston 151 moving from a central portion toward an outer side inside the first cylinder chamber 121, an air-fuel mixture, which is a mixture of fuel and air, is sucked into the first cylinder chamber 121. Simultaneously, the first crankshaft 143 and the second crankshaft 153 rotate. Referring to FIG. 5, in the intake stroke, in the advancing/retreating mechanism 20, the first intake valve 181 brings the first extension space 331 into an open state, while the first exhaust valve 191 brings the first extension space 331 into a closed state. Specifically, the crank gear 31 rotates, and along with this, the driven gear 30 on which the belt 32 is stretched also rotates. Then, the camshaft 21 connected to the driven gear 30 rotates together with the first intake cam 231. By the first intake cam 231 rotating, the first arm 271 and the first intake valve 181 are pushed rearward. Thereby, a front end portion of the first intake valve 181 is pushed into the first extension space 331, and the first intake valve installation hole 351 shown in FIG. 3A enters an open state. Therefore, the air-fuel mixture can be sucked into the first cylinder chamber 121 via the first intake valve installation hole 351 and the first extension space 331 shown in FIG. 3A.

In the compression stroke, referring to FIG. 4, due to inertia of the rotating first crankshaft 143 and second crankshaft 153, the first piston 141 and the second piston 151 are pushed out toward the central portion, and the air-fuel mixture is compressed inside the first cylinder chamber 121. Referring to FIG. 5, in the advancing/retreating mechanism 20, the first intake valve 181 brings the first extension space 331 into a closed state, and the first exhaust valve 191 brings the first extension space 331 into a closed state. Specifically, as the camshaft 21 further rotates, the first intake cam 231 no longer pushes the first intake valve 181 via the first arm 271. Thereby, the first intake valve 181 is displaced forward by the urging force of the spring 381, and the first intake valve installation hole 351 shown in FIG. 3A enters a closed state. On the other hand, the first exhaust cam 221 is not pushing the first exhaust valve 191 via the first pushrod 241 and the first rocker arm 251. Therefore, the first exhaust valve 191 is arranged on a rear side by the urging force of the spring 383, and closes the first extension space 331. Therefore, the first extension space 331 and the first cylinder chamber 121 enter a closed state, and the air-fuel mixture can be compressed inside the first cylinder chamber 121.

In the combustion stroke, by the first spark plug 261 shown in FIG. 5 igniting in the first extension space 331, the air-fuel mixture combusts inside the first extension space 331 and the first cylinder chamber 121 shown in FIG. 4, and thereby the first piston 141 and the second piston 151 are pushed out to an outer end portion, which is a bottom dead center. Referring to FIG. 5, in the advancing/retreating mechanism 20, similarly to the compression stroke, the first intake valve 181 brings the first extension space 331 into a closed state, and the first exhaust valve 191 brings the first extension space 331 into a closed state. That is, the states of the first intake valve 181 and the first exhaust valve 191 are similar to the aforementioned compression stroke.

In the exhaust stroke, referring to FIG. 4, due to inertia of the rotating first crankshaft 143 and second crankshaft 153, the first piston 141 and the second piston 151 are pushed inward, and gas after combustion existing inside the first cylinder chamber 121 is discharged to the outside. Referring to FIG. 5, in the advancing/retreating mechanism 20, the first intake valve 181 brings the first extension space 331 into a closed state, while the first exhaust valve 191 brings the first extension space 331 into an open state. Specifically, because the first intake cam 231 does not push the first intake valve 181 via the first arm 271, the first intake valve 181 closes the first extension space 331 by the urging force of the spring 381. On the other hand, the first exhaust cam 221 pushes the pushrod 24 rearward, and thereby the rotated first rocker arm 251 pushes the first exhaust valve 191 forward. Thereby, the first exhaust valve 191 brings the first extension space 331 into an open state. Thereby, the gas after combustion inside the first cylinder chamber 121 is released to the outside from the first exhaust valve installation hole 361 shown in FIG. 3B.

Such operation is also similar with respect to the third engine part 16, the fourth engine part 17, the second intake valve 182, and the second exhaust valve 192.

In the engine unit 13, the stroke can be divided by the two pistons, the first piston 141 and the second piston 151, that reciprocate inside one first cylinder chamber 121. Therefore, compared to a normal engine, the compression ratio of the mixed gas can be increased. Also, because the first piston 141 and the second piston 151 oppose each other inside the first cylinder chamber 121, a cylinder head required in a general engine becomes unnecessary, and the configuration of the engine unit 13 is simple and lightweight. Also, respective members constituting the engine unit 13, that is, the first piston 141 and the second piston 151, the first crankshaft 143 and the second crankshaft 153, and the like, are arranged opposing each other, and operate so as to oppose each other. From this, vibrations generated from the respective members of the engine unit 13 are cancelled out, and vibrations generated to the outside from the entire engine unit 13 can be reduced. Therefore, by mounting the engine unit 13 having such a structure on a flight apparatus, miniaturization, weight reduction, and low vibration of the flight apparatus can be achieved. In particular, by reducing vibration, adverse effects on arithmetic control devices such as attitude control and motor output control, and precision instruments such as GPS sensors can be prevented. Also, it is possible to prevent delivery cargo transported by the flight apparatus from being damaged by vibration.

Referring to FIG. 5, according to the present embodiment, by advancing and retreating the intake valve 18 by the intake cam 23, and advancing and retreating the exhaust valve 19 by the pushrod 24, even when geometric constraints in the vicinity of the cylinder chamber 12 are severe, the advancing/retreating mechanism 20 can be arranged in the vicinity of the cylinder chamber 12. Also, since the pushrod 24 is used, the number of camshafts 21 is reduced, and thereby the configuration of the engine 10 can be simplified.

Furthermore, according to the present embodiment, because the intake valve 18 and the exhaust valve 19 are arranged sandwiching the extension space 33, the intake valve 18 and the exhaust valve 19 are consequently arranged densely, but because the intake valve 18 or the exhaust valve 19 is advanced and retreated via the pushrod, the configuration around the extension space 33 can be simplified.

Furthermore, according to the present embodiment, even when a plurality of cylinder chambers 12 are adjacent and a large number of intake valves 18 and exhaust valves 19 are arranged, by optimizing the configuration of the camshaft 21 and the pushrod, the configuration of the entire engine 10 can be simplified.

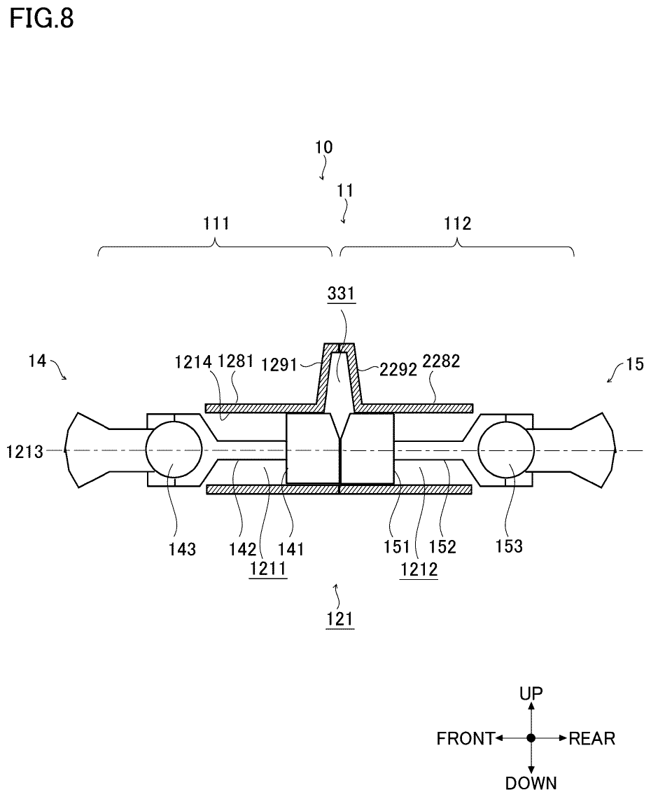

FIG. 8 is a cross-sectional view along the line B-B in FIG. 4, and shows a wall portion of the engine block 11 that forms the first cylinder chamber 121 and the first extension space 331.

As described above, the first cylinder chamber 121 is a space having a substantially cylindrical shape. The first cylinder chamber 121 has a first cylinder chamber front part 1211 on a front side, and a first cylinder chamber rear part 1212 connected to a rear end of the first cylinder chamber front part 1211. At a substantially central portion in the front-rear direction of the first cylinder chamber 121, the first extension space 331 projects upward from an upper surface of the first cylinder chamber 121. The first cylinder chamber front part 1211, the first cylinder chamber rear part 1212, and the first extension space 331 communicate with each other.

The first cylinder chamber 121 and the first extension space 331 of such a configuration are spaces surrounded by a wall portion formed inside the engine block 11.

Specifically, the first cylinder chamber front part 1211 is a substantially cylindrical space surrounded by a first cylinder wall portion 1281. The first cylinder wall portion 1281 is a tubular wall formed inside the first engine block 111. A front end and a rear end of the first cylinder wall portion 1281 are in an open state.

The first cylinder chamber rear part 1212 is a substantially cylindrical space surrounded by a second cylinder wall portion 2282. The second cylinder wall portion 2282 is a tubular wall formed inside the second engine block 112. A front end and a rear end of the second cylinder wall portion 2282 are in an open state.

The first extension space 331 is a space surrounded by a first extension wall portion 1291 and a second extension wall portion 2292. The first extension wall portion 1291 is a substantially tongue-shaped portion extending upward from an upper end portion of the first cylinder wall portion 1281 at a rear end of the first cylinder wall portion 1281. The second extension wall portion 2292 is a substantially tongue-shaped portion extending upward from an upper end portion of the second cylinder wall portion 2282 at a front end of the second cylinder wall portion 2282.

The first cylinder chamber 121 is a substantially cylindrical space having a first central axis 1213 extending along the front-rear direction. The first cylinder chamber 121 has a first side surface 1214. The first side surface 1214 is a surface constituted by inner surfaces of the first cylinder wall portion 1281 and the second cylinder wall portion 2282. The first extension space 331 extends from the first side surface 1214. Specifically, the first extension space 331 is a space extending upward, which is a direction orthogonal to the first central axis 1213 of the first cylinder chamber 121. The first extension space 331 communicates with the first cylinder chamber 121.

Such matters are also similar with respect to the aforementioned second cylinder chamber 122.

Although the embodiment of the present invention has been described above, the present invention is not limited thereto, and modifications can be made without departing from the gist of the present invention. Also, the respective forms described above can be combined with each other.

For example, referring to FIG. 5, although the exhaust valve 19 was advanced and retreated by the pushrod 24, it can also be configured such that the intake valve 18 is advanced and retreated by the pushrod 24, and the exhaust valve 19 is advanced and retreated not via the pushrod 24.

Furthermore, although the aforementioned engine 10 had a plurality of cylinder chambers 12, the number of cylinder chambers 12 can also be one.

### REFERENCE SIGNS LIST

10 Engine
11 Engine block
111 First engine block
112 Second engine block
113 Third engine block
114 Fourth engine block
12 Cylinder chamber
121 First cylinder chamber
1211 First cylinder chamber front part
1212 First cylinder chamber rear part
122 Second cylinder chamber
1221 Second cylinder chamber front part
1222 Second cylinder chamber rear part
1213 First central axis
1214 First side surface
1291 First extension wall portion
13 Engine unit
14 First engine part
141 First piston
142 First connecting rod
143 First crankshaft
15 Second engine part
151 Second piston
152 Second connecting rod
153 Second crankshaft
16 Third engine part
161 Third piston
162 Third connecting rod
163 Third crankshaft
17 Fourth engine part
171 Fourth piston
172 Fourth connecting rod
173 Fourth crankshaft
18 Intake valve
181 First intake valve
182 Second intake valve
19 Exhaust valve
191 First exhaust valve
192 Second exhaust valve
20 Advancing/retreating mechanism
21 Camshaft
22 Exhaust cam
221 First exhaust cam
222 Second exhaust cam
1281 First cylinder wall portion
2282 Second cylinder wall portion
2292 Second extension wall portion
23 Intake cam
231 First intake cam
232 Second intake cam
24 Pushrod
241 First pushrod
242 Second pushrod
25 Rocker arm
25 First rocker arm
252 Second rocker arm
26 Spark plug
261 First spark plug
262 Second spark plug
271 First arm
272 Second arm
29 Arm shaft
30 Driven gear
31 Crank gear
32 Belt
33 Extension space
331 First extension space
3311 First extension space front part
3312 First extension space rear part
332 Second extension space
3321 Second extension space front part
3322 Second extension space rear part
34 Combustion chamber
341 First combustion chamber
342 Second combustion chamber
35 Intake valve installation hole
351 First intake valve installation hole
352 Second intake valve installation hole
36 Exhaust valve installation hole
361 First exhaust valve installation hole
362 Second exhaust valve installation hole
37 Plug installation hole
371 First plug installation hole
372 Second plug installation hole
381 Spring
382 Spring
383 Spring
384 Spring
40 First contact surface
41 Second contact surface

1-5. (canceled)

6. An engine comprising: a cylinder chamber, an intake valve, an exhaust valve, and an advancing/retreating mechanism that advances and retreats the intake valve and the exhaust valve,
wherein the advancing/retreating mechanism has a camshaft, a first cam, a second cam, a pushrod, and a rocker arm,
the first cam is fixed to the camshaft and is configured to advance and retreat one of the intake valve and the exhaust valve,
the second cam is separate from the first cam and is configured to advance and retreat the pushrod,
the rocker arm is rotated by the pushrod and is configured to advance and retreat the other of the intake valve and the exhaust valve,
the first cam advances and retreats a plurality of the intake valves, the second cam, via the pushrod, advances and retreats the exhaust valve, inside the cylinder chamber,
when the axial direction of the cylinder chamber is taken as a front-rear direction, pistons oppositely arranged along the front-rear direction are arranged so as to reciprocate, it has an extension space extending laterally from an intermediate portion of the cylinder chamber in the front-rear direction,
each of the intake valves is provided so as to be capable of advancing and retreating with respect to the extension space from a front side, the exhaust valve is provided so as to be capable of advancing and retreating with respect to the extension space from a rear side,
the cylinder chamber has a first cylinder chamber and a second cylinder chamber adjacent to the first cylinder chamber, inside the first cylinder chamber,
a first piston and a second piston are housed so as to reciprocate, inside the second cylinder chamber, a third piston and a fourth piston are housed so as to reciprocate, it has a first extension space extending laterally from an intermediate portion of the first cylinder chamber in the front-rear direction, it has a second extension space extending laterally from an intermediate portion of the second cylinder chamber in the front-rear direction,
the intake valve has a first intake valve and a second intake valve, the exhaust valve has a first exhaust valve and a second exhaust valve,
the first intake valve is provided so as to be capable of advancing and retreating with respect to the first extension space from the front side, the first exhaust valve is provided so as to be capable of advancing and retreating with respect to the first extension space from the rear side, the second intake valve is provided so as to be capable of advancing and retreating with respect to the second extension space from the front side, and the second exhaust valve is provided so as to be capable of advancing and retreating with respect to the second extension space from the rear side.

7. The engine according to claim 6, wherein the number of the intake valves is greater than the number of the exhaust valves, and a spark plug is arranged on the side of the extension space where the exhaust valve is provided, so as to be exposed.
